(19) United States
(12) Patent Application Publication
(10) Pub. No.: US 2006/0111604 A1
(43) Pub. Date: May 25, 2006

(54) Method for applying asbestos digestion chemical to asbestos-containing materials

(76) Inventors: Leonidas Petrakis, Oakland, CA (US); Ronald P. Webster, Shoreham, NY (US)

Correspondence Address: BROOKHAVEN SCIENCE ASSOCIATES/;BROOKHAVEN NATIONAL LABORATORY, BLDG. 475D - P.O. BOX 5000, UPTON, NY, 11973, US

(21) Appl. No.: 10/993,480

(22) Filed: Nov. 22, 2004

(51) Int. Cl. A62D 3/00

(52) U.S. Cl. 588/313

(57) ABSTRACT

A method for applying liquid, foam and/or gel forms of asbestos digestion chemicals through painted, coated or otherwise protected or encapsulated surfaces of asbestos-containing materials. The method includes forming an injection aperture in the encapsulating material and contacting the hazardous asbestos-containing material with asbestos digestion material through the injection aperture. As a result of the treatment, the asbestos digestion material converts the hazardous asbestos-containing material into non-hazardous material.

This invention was made with Government support under contract number DE-AC02-98CH10886, awarded by the U.S. Department of Energy. The Government has certain rights in the invention.

### FIELD OF THE INVENTION

The present invention relates to methods for applying asbestos digestion chemicals to asbestos-containing materials that have been sealed or encapsulated. Sealing or encapsulation prevents asbestos from being released in the air but they still remain hazardous. Treatment is required in order to render the asbestos non-hazardous.

### BACKGROUND OF THE INVENTION

For a number of years now it has been recognized that many chronic diseases are associated with the inhalation of airborne asbestos fibers, including both chrysotile and amosite asbestos. These diseases include lung cancer, chronic fibrosis of the lung lining, and mesothelioma, a rare but fatal cancer of the lungs.

Government agencies have passed regulations banning the use of products containing either chrysotile or arnosite asbestos in building construction. However, asbestos-containing materials are still present in many structures built before the regulations went into effect and remain a potential health threat. Building owners have used various methods to address the dangers posed by asbestos and to ensure that asbestos fibers do not enter occupied space. One temporary and relatively inexpensive method is encapsulation, where the asbestos containing materials are sprayed with a surface-coating material to seal-in the asbestos. This method, however, provides only a temporary remedy since the asbestos fibers are only isolated by the encapsulation. Moreover, merely encapsulating asbestos covered pipes will not prevent exposure when a pipe bursts or the integrity of the encapsulation is otherwise compromised.

Various treatment methods using a variety of chemicals have been used to treat hazardous asbestos-containing material that has been removed from pipes or equipment. The asbestos digestion chemicals convert chrysotile and/or amosite asbestos-containing matrices, such as thermal insulation materials, found on pipes or other metal surfaces, to non-regulated environment benign materials. However, all of these methods require that the asbestos-containing material be removed before it is treated. These removal efforts are not only expensive, but also involve a risk to personnel involved in the removal and persons in the immediate area.

Asbestos is a commercial term applied to a group of silicate minerals which occur in fibrous form. There are six principal asbestos minerals. Of these six minerals, only one, chrysotile asbestos, belongs to the group classified as serpentine asbestos, that is, minerals characterized by long fibers which are serpentine in shape. The chemical composition of chrysotile asbestos may be represented as: Mg₃(Si₂O₅)(OH)₄ or 3MgO^{.}2SiO₂^{.} H₂O. Each chrysotile asbestos fiber is a long hollow tube. The diameters of the individual tubes are 20 to 50 nm. The length-to-diameter ratio can vary from 20:1 to well over 10,000:1. The crystalline structure of chrysotile asbestos consists of alternating layers of silica and magnesium oxide/hydroxide bound to each other through covalently shared oxygen. These layers are transverse to the fiber axis.

The other varieties of asbestos are typically silicates of magnesium, manganese, iron, calcium and sodium. These varieties of asbestos belong to the amphibole (straight fiber) group of minerals. The amphibole's fundamental unit is a chain of SiO₄ tetrahedra linked by corner oxygen atoms, and the chains are linked laterally by cations, such as Mg, Mn, and Fe. Grunerite asbestos, more commonly referred to as amosite, is one of the most readily available and commercially used varieties of the amphibole group of minerals. The chemical composition of amosite asbestos may be represented as: Fe₇ Si₈ O₂₂ (OH)₂.

Although about 90% of the world production is the chrysotile form of asbestos, amosite is widely used in high-temperature insulation, acid-resistant products and asbestos cement. Particularly, amosite is used as high-temperature insulation around iron and other metal pipes and surfaces. Iron may include iron alloys such as alloys with cobalt, nickel, chromium, manganese, carbon, including steel and stainless steel. Other metals used in pipes may include copper, aluminum, brass, zinc or any other commonly used metal for piping or building construction.

Asbestos-containing materials often include either chrysotile-bearing and/or amosite-bearing materials. For example, fire proofing is a chrysotile bearing material which also includes gypsum and vermiculite. Thermal insulation is an example of amosite fiber bearing material which also includes cement and mineral fillers.

When the morphology of chrysotile asbestos is altered by becoming non-regulated or “unrolled” or “uncoiled” the hazardous nature of chrysotile asbestos ceases. Non-regulated, environmentally benign components refers to components which are formed after asbestos-containing materials are morphologically altered to reduce or nullify their hazardous effect on mammals. Thus, the non-regulated chrysotile asbestos is environmentally benign.

When chrysotile asbestos is exposed to acids, leaching and lixiviating ofthe magnesium from chrysotile asbestos occur as a result of the interaction between the hydroxyl groups in the magnesium hydroxide layer and the hydrogen ions liberated from the acids. Consequently, the magnesium hydroxide layer is eliminated. The exposure of the chrysotile asbestos to acid results in the conversion of the silicate layer into its various components. More specifically, the acid breaks the Si-OH linkages of the silicate tetrahedron of chrysotile asbestos.

As a result of the above reactions, the tubular scroll-like structure of chrysotile asbestos is converted into an open and unrolled one. Hence, the chrysotile asbestos is converted to a non-regulated environmentally benign component.

Other varieties of asbestos are silicates of magnesium, manganese, iron, calcium, and sodium. These varieties of asbestos belong to the amphibole (straight fiber) group of minerals. The structure of amosite consists of double-silicate tetrahedral chains which sandwich a layer of edge shared R²⁺O₆ and R³⁺O₆ octahedra, where R is Mg, Fe and Mn. A typical composition of amosite asbestos can be represented as: FeSi₈O₂₂(OH)₂.

Many building products, such as thermal insulation or fire-proofing incorporate only one type of asbestos, but more frequently mixtures of one or more asbestos minerals are used. For example, thermal insulation used in furnaces and power plant pipes can contain amosite from about 35% by weight to about 60% by weight with the reminder consisting of filler material such as gypsum, vermiculite, and/or other inert minerals. A preferred range for asbestos content of fire proofing insulation such as that used for fire doors is from about 2% to about 45% by weight asbestos of which about 30% by weight is amosite, about 15% by weight is chrysotile with the remainder being filler materials. The ranges for asbestos content are quite wide and can vary from 2% to 3% by weight up to 60% to 70% by weight asbestos.

Thus, the wide use of amosite, and to a lesser extent chrysotile, as thermal and fire proof insulation for metal pipes and other metal surfaces, warrants the use of converting agents that will not corrode the underlying metal. It is, therefore, an object of the present invention to provide a composition and method for converting asbestos-containing materials to non-regulated, environmentally benign materials and inhibiting corrosion of the metal surface covered by the asbestos-containing materials.

Until now, building owners who had encapsulated asbestos could only guarantee complete safety by the complete removal of all chrysotile and/or amosite asbestoscontaining materials. The drawback to this method is that it involves a significant amount of time and expense because a building must be sealed off, the asbestos-containing materials removed (usually by hand to minimize the dust), and once removed, the asbestos-containing materials must be disposed. In addition, many safeguards must be employed to prevent inhalation of airborne asbestos by workers and others in the vicinity of the working area and government regulations often require the continuous monitoring of the air while the work is being done. Furthermore, because of the hazardous nature of the asbestos-containing material that is removed, the disposal is very costly. Thus, there is a need for a method of in-situ treatment of encapsulated asbestos that converts the hazardous asbestos-containing materials to non-regulated environmentally benign materials without removing the encapsulating material.

### SUMMARY OF THE INVENTION

The present invention provides methods for applying liquid, foam and/or gel forms of asbestos digestion chemicals through painted, coated or otherwise protected or encapsulated surfaces of asbestos-containing materials (ACM). A preferred method includes forming an aperture in the encapsulation material and then injecting the asbestos digestion material into the asbestos-containing materials.

A preferred method of the present invention for treating encapsulated, hazardous asbestos-containing material includes the steps of: (1) providing an encapsulated hazardous asbestos-containing material isolated from the surrounding environment by an encapsulating material; (2) forming an injection aperture in the encapsulating material, preferably a plurality of injection apertures are formed; (3) providing an asbestos digestion material; and (4) contacting the hazardous asbestos-containing material with the asbestos digestion material through the injection aperture to form a treated asbestos material. As a result of the treatment, the asbestos digestion material converts the hazardous asbestos-containing material into non-hazardous material.

In various embodiments of the present invention, the asbestos digestion material can be a liquid, a foam, a gel or a combination thereof and preferably includes an acid. In a preferred embodiment, the hazardous asbestos-containing material is contacted with the asbestos digestion material through the at least one aperture using an injection device, which preferably includes a nozzle and a pressurized tank. The injection device can also be a syringe.

In another embodiment of the present invention, the method includes forming a discharge aperture in the encapsulating material which can be used as a vent. Preferably, a filter is connected between the discharge aperture and the vent. A preferred embodiment of the method of the present invention includes the step of sealing the injection and discharge apertures that were formed. The method of the present invention can also include testing the asbestos-containing material prior to contacting it with the asbestos digestion material. Preferably, the method also includes testing the treated asbestos material for the presence of hazardous asbestos. This confirms that the hazardous asbestos-containing material has been sufficiently treated to render it non-hazardous.

The method of the present invention can be used for treating encapsulated, hazardous asbestos-containing material that surrounds pipes of various diameters. For any size pipe, the injection apertures are formed along the length of the pipe at intervals equal to at least one pipe diameter, preferably at least three pipe diameters and most preferably at intervals of from 5 to 10 pipe diameters. The method of the present invention can also be used for treating encapsulated, hazardous asbestos-containing material that surrounds a boiler, a tank, a pump or any other type of equipment that may be insulated. In a preferred embodiment the encapsulated, hazardous asbestos-containing material covers a wall, ceiling, floor or similar substantially flat surface. The injection apertures for these applications are formed at intervals of at least 12 inches, preferably at intervals of at least 18 inches and most preferably at intervals of at least 24 inches.

Other improvements which the present invention provides over the prior art will be identified as a result of the following description which sets forth the preferred embodiments of the present invention. The description is not in any way intended to limit the scope of the present invention, but rather only to provide a working example of the present preferred embodiments. The scope of the present invention will be pointed out in the appended claims.

### BRIEF DESCRIPTION OF THE DRAWINGS

Other objects and many attendant features of this invention will be readily appreciated as the invention becomes better understood by reference to the following detailed description when considered in connection with the accompanying drawings wherein:

FIG. 1 is a cross-sectional view of a pipe insulated with asbestos covered with an outer layer of encapsulating material.

FIG. 2 shows an embodiment of the present invention wherein an asbestos digestion material is gravity fed into an encapsulated hazardous asbestos-containing material covering a pipe.

FIG. 3 shows an embodiment of the present invention wherein a pump is used to inject asbestos digestion material into an encapsulated hazardous asbestos-containing material covering a pipe.

### DETAILED DESCRIPTION OF THE INVENTION

The present invention provides a method for applying asbestos digestion materials to hazardous asbestos-containing materials covering metal pipes or other metal surfaces in order to convert these hazardous materials to environmentally benign, non-regulated components and, optionally, inhibiting the corrosion of the metal pipes and surfaces.

The methods of the present invention can be used to treat hazardous asbestos- containing materials with any liquid, foam and/or gel asbestos digestion material. As used herein, the term “asbestos digestion material” covers any chemical or combination of chemicals and or materials that can be used to render hazardous asbestos-containing materials less hazardous or benign. Preferred asbestos digestion materials for use in the methods of the present invention are disclosed in U.S. Pat. Nos. 5,763,738; 6,005,158; and 6,160,195 to Sugama, et al. All three of these references are incorporated by reference herein in their entirety.

The present invention contacts asbestos digestion material with encapsulated hazardous asbestos-containing material using a system which includes an injection device. The preferred injection device is a syringe which includes a nozzle of varying length and a system for delivering a regulated amount of asbestos digestion material in the form of a liquid, a foam and/or a gel through the nozzle. The delivery system can include a pipe, hose or tubing in combination with one or more valves, tanks and/or pumps. Any system or suitable for delivering the asbestos digestion material through the aperture and contacting the asbestos-containing material can be used in the present invention.

In preferred embodiments, the asbestos digestion material is delivered to the nozzle using a gravity-flow system that includes a reservoir containing the asbestos digestion material. For the purposes of the present invention, the term “nozzle” is defined as any device that delivers the asbestos digestion material through the aperture in the encapsulation material and includes piping fittings and connectors as well as the ends of pipes, tubes or hoses that are inserted through the aperture without being connected to another device.

In another embodiment, the syringe includes a hollow barrel fitted with a plunger and a hollow needle. The size of the hollow barrel can vary so that the amount of asbestos digestion material delivered can vary over a wide range. This embodiment provides portability and convenience and it allows relatively small amounts of hazardous asbestos- containing material to be treated without the use of complex equipment and systems.

Encapsulating asbestos-containing material provides protection as long as the encapsulating material maintains a complete seal around the hazardous asbestos-containing material. However, once the encapsulating layer is breached, the hazardous asbestos-containing material can escape into the surrounding environment and pose a serious health threat to persons and animals that may be exposed to it. Therefore, the present invention treats the asbestos-containing material and renders it non-hazardous while it is still inside the layer of encapsulating material.

The method of the present invention first forms an aperture in the layer of encapsulating material in order to facilitate the application of the asbestos digestion material to the hazardous asbestos-containing material. An injection device, preferably a syringe, a nozzle, a hollow probe or any similar device capable of delivering a liquid, foam or gel material, is then inserted through the aperture and a predetermined amount of asbestos digestion material is discharged into the hazardous asbestos-containing material. The asbestos digestion material reacts with the hazardous asbestos-containing material and converts it into a non-hazardous asbestos-containing material. In a preferred embodiment, a second aperture is formed in the layer of encapsulating material to act as a vent. This allows the asbestos digestion material to flow freely through the asbestos-containing material without a build up of pressure inside the layer of encapsulated material.

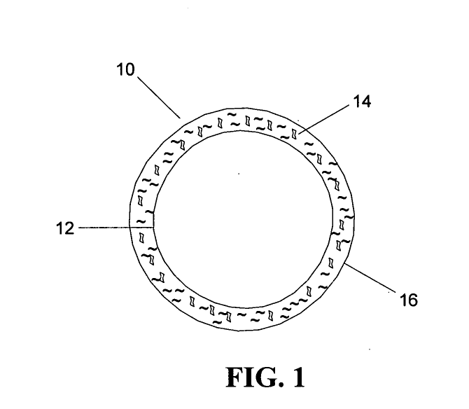

FIG. 1 shows a cross-sectional view of a metal pipe 12 insulated with an asbestos- containing material 14 that is encapsulated with a layer of encapsulating material 16. Typically, the encapsulating material 16 is an epoxy based composition that can be either painted or sprayed onto the surface of the insulation to form a layer which contains the hazardous asbestos-containing material 14. The encapsulating material 16 isolates the asbestos-containing material 14 from the atmosphere where it could harm persons who came in contact with it. Other encapsulating materials can also be used and these materials are well known to those skilled in the art. In addition to pipes, the encapsulating material 16 can be used to encapsulate asbestos on walls, ceilings and floors and various types of equipment, such as boilers, hot water tanks, and pumps. The present invention is intended to be used for any application where an asbestos-containing material is encapsulated.

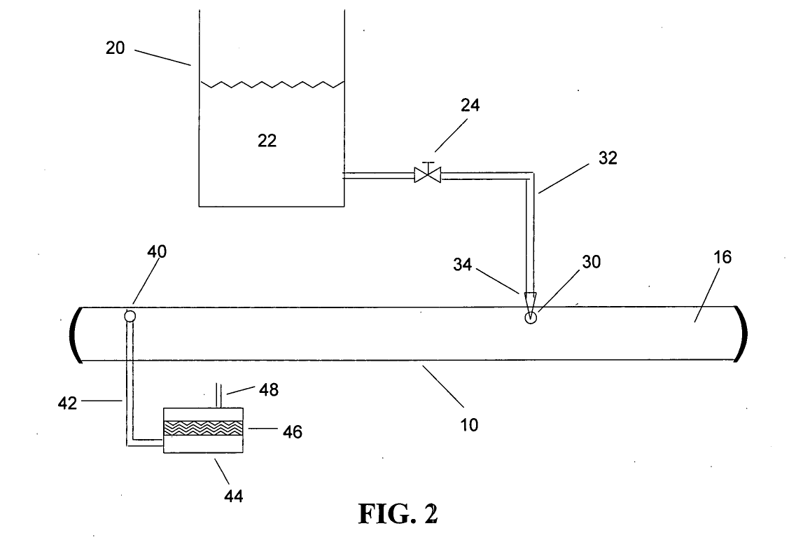

FIG.2 shows an embodiment of the present invention wherein asbestos digestion material 22 is contacted with hazardous asbestos-containing material 14 in an encapsulated asbestos covered pipe 10. In this embodiment, the asbestos digestion material 22 is stored in a tank 20 and gravity fed through an aperture 30 in the encapsulating material 16. This aperture 30 is also referred to herein as either the “first aperture” or the “injection aperture.” A pipe (or tube) 32 connects the tank 20 with the encapsulated pipe 10 and the flow rate is controlled using a manual valve 24. In a preferred embodiment, a nozzle 34 is provided on the feed pipe 32. The amount of asbestos digestion material 22 that is used is determined by several factors, including the amount of hazardous asbestos-containing material 14 being treated and the type of asbestos digestion material 22 being used.

In a preferred embodiment, another aperture 40 is formed in the encapsulating material 16 as illustrated in FIG. 2. This aperture 40 is also referred to herein as the “second aperture” or the “discharge aperture.” The second aperture is preferably located at a high point in the pipe 10. The second aperture 40 acts as a vent to allow the asbestos digestion material introduced through the first aperture 30 to freely circulate throughout the hazardous asbestos containing material surrounding the pipe 10. The second aperture 40 is preferably connected by a pipe 42 (a hose or tubing can also be used) to a filtration system 50 which includes a vessel 52 that collects any asbestos digesting material 22 that may be discharged through the second aperture 40. The filtration system 50 also includes a filter 54 which removes any asbestos fibers before the air/gas is discharged through a vent 56 to the atmosphere. The filtration system 50 ensures that airborne asbestos fibers are not inadvertently released.

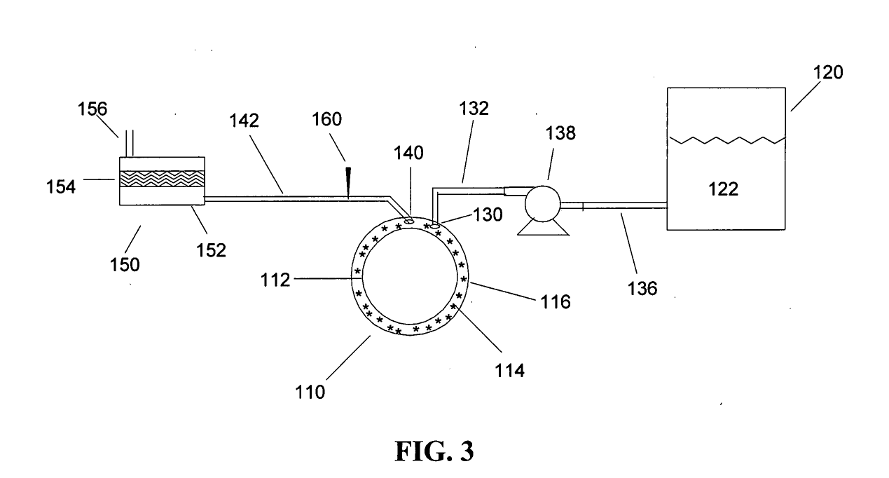

FIG. 3 shows an embodiment of the present which uses a pump 138 to inject asbestos digestion material 122 from tank 120 through the aperture 130 in the encapsulated material 116. The pump 138 is connected to the tank 120 through a suction pipe 136 (a hose or tubing can also be used) and delivers the asbestos digestion material 122 through a discharge pipe 132 to the aperture 130 in the encapsulated material 116. The pump 138 provides a constant flow rate of asbestos digestion material 122 to the asbestos-containing material 114 that is being treated. In a preferred embodiment, the pump 138 is a metering pump which allows the flow rate to be varied by the operator. In a most preferred embodiment, a sensor 160 is positioned at either the second aperture 140 or in the discharge pipe 142 or the vessel 152 for the filtration system 150. When the sensor 160 detects the presence of the asbestos digestion material 122, it indicates that the encapsulated material 114 has been substantially saturated with the asbestos digestion material 122. The sensor 160 sends a signal to stop the metering pump 138 so that asbestos digestion material 122 is not unnecessarily used.

Multiple injection apertures and discharge apertures can be used for injecting asbestos digestion material into encapsulated hazardous asbestos containing material. The number of apertures required depends on the particular application and takes into consideration the following factors: (1) the type and density of the hazardous asbestos-containing material, (2) the thickness of the asbestos-containing material, (3) the type of asbestos digestion material being used (for example more apertures are required when the asbestos digestion material is a gel since it does not circulate as well as a liquid), (4) the size and shape of the pipe, flat surface or equipment that is covered with the encapsulated asbestos-containing material (for example, pipes with numerous bends require more apertures than straight runs of pipe), and (5) the type of injection system being used (a pressurized system that uses a pump to inject the asbestos digestion material requires fewer apertures than a gravity feed system).

The number of injection apertures and discharge apertures should be sufficient to guarantee that all of the hazardous asbestos-containing material is contacted by the asbestos digestion material and rendered non-hazardous. The number of injection apertures formed along a length of pipe can be calculated based on the diameter of the pipe. Typically, injection apertures are formed every 10 or 20 pipe diameters. In preferred embodiments, injection apertures are formed every 5 pipe diameters and most preferably every 3 diameters. For large pipes (for example, pipes larger than 12 inches in diameter), it may be necessary to form injection apertures at intervals of less than one pipe diameter. After the treatment is completed, the injection and discharge apertures are sealed.

The injection apertures formed in encapsulated, hazardous asbestos-containing material that surrounds a tank or a piece of equipment are located at intervals of at least 12 inches, preferably at intervals of at least 18 inches and most preferably at intervals of at least 24 inches. The injection apertures are located near the top of the equipment so that the asbestos digestion material can gravity-flow through the hazardous asbestos-containing material. Accordingly, the injection apertures are located closer together near the top of the equipment. In applications where the equipment has an irregular shape, it may be necessary to locate the injection apertures at intervals of less than 12 inches.

After the encapsulated asbestos-containing material has been treated, test samples can be taken to confirm that the hazardous asbestos-containing material has been rendered non-hazardous. A preferred method of testing is done by taking bore samples at regular intervals along the pipe or flat surface (e.g., wall, ceiling or floor) or around the equipment that is covered with the encapsulated asbestos. The samples can then be analyzed to determine if the asbestos is non-hazardous. Such testing procedures are well known to those skilled in the art.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

1. A method for treating encapsulated, hazardous asbestos-containing material comprising:
providing an encapsulated hazardous asbestos-containing material isolated from the surrounding environment by an encapsulating material;
forming an injection aperture in said encapsulating material;
providing an asbestos digestion material; and
contacting said hazardous asbestos-containing material with said asbestos digestion material through said injection aperture to form a treated asbestos material; wherein said asbestos digestion material converts said hazardous asbestos-containing material into non-hazardous material.

2. The method for treating encapsulated, hazardous asbestos-containing material in accordance with claim 1, wherein said asbestos digestion material is a liquid, a foam, a gel or a combination thereof.

3. The method for treating encapsulated, hazardous asbestos-containing material in accordance with claim 1, wherein said hazardous asbestos-containing material is contacted with said asbestos digestion material through said at least one aperture using an injection device.

4. The method for treating encapsulated, hazardous asbestos-containing material in accordance with claim 3, wherein said injection device comprises a nozzle and a pressurized tank.

5. The method for treating encapsulated, hazardous asbestos-containing material in accordance with claim 1, wherein said injection device is a syringe.

6. The method for treating encapsulated, hazardous asbestos-containing material in accordance with claim 1, further comprising forming a discharge aperture in said encapsulating material, wherein said discharge aperture is used as a vent.

7. The method for treating encapsulated, hazardous asbestos-containing material in accordance with claim 6, further comprising connecting a filter between said discharge aperture and said vent.

8. The method for treating encapsulated, hazardous asbestos-containing material in accordance with claim 1, further comprises testing the asbestos-containing material prior to contacting with said asbestos digestion material.

9. The method for treating encapsulated, hazardous asbestos-containing material in accordance with claim 1, wherein said asbestos digestion material comprises an acid.

10. The method for treating encapsulated, hazardous asbestos-containing material in accordance with claim 1, further comprising sealing said injection aperture.

11. The method for treating encapsulated, hazardous asbestos-containing material in accordance with claim 1, wherein a plurality of injection apertures are formed.

12. The method for treating encapsulated, hazardous asbestos-containing material in accordance with claim 1, further comprising testing the treated asbestos material for the presence of hazardous asbestos.

13. The method for treating encapsulated, hazardous asbestos-containing material in accordance with claim 1, wherein the encapsulated, hazardous asbestos-containing material surrounds a pipe and wherein said pipe has a diameter.

14. The method for treating encapsulated, hazardous asbestos-containing material in accordance with claim 13, wherein the injection apertures are formed along the length of the pipe at intervals equal to at least one pipe diameters.

15. The method for treating encapsulated, hazardous asbestos-containing material in accordance with claim 13, wherein the injection apertures are formed along the length of the pipe at intervals equal to at least three pipe diameters.

16. The method for treating encapsulated, hazardous asbestos-containing material in accordance with claim 13, wherein the injection apertures are formed along the length of the pipe at intervals of from 5 to 10 pipe diameters.

17. The method for treating encapsulated, hazardous asbestos-containing material in accordance with claim 1, wherein the encapsulated, hazardous asbestos-containing material surrounds a boiler, a tank or a pump.

18. The method for treating encapsulated, hazardous asbestos-containing material in accordance with claim 17, wherein the injection apertures are formed at intervals of at least 12 inches.

19. The method for treating encapsulated, hazardous asbestos-containing material in accordance with claim 1, wherein the encapsulated, hazardous asbestos-containing material surrounds a wall, ceiling or floor surface.
